(19) United States
(12) Patent Application Publication
(10) Pub. No.: US 2011/0183172 A1
(43) Pub. Date: Jul. 28, 2011

(54) Sealed Battery Cell

(75) Inventors: Akira UNNO, Hitachinaka-shi (JP); Kenji Nakai, Mito-shi (JP); Hideki Shinohara, Hitachiota-shi (JP)

(73) Assignee: Hitachi Vehicle Energy, Ltd., Hitachinaka-shi (JP)

(21) Appl. No.: 13/013,349

(22) Filed: Jan. 25, 2011

(30) Foreign Application Priority Data
Jan. 28, 2010 (JP) 2010-017187

(51) Int. Cl. H01M 2/10; H01M 10/36

(52) U.S. Cl. 429/94; 429/186

(57) ABSTRACT

A sealed battery cell includes: a coiled electrode group comprising a positive electrode, a negative electrode, and a separator wound around a winding core; a cylindrical battery cell container having an open end and a bottom surface, that contains the coiled electrode group; and a sealed cover swaged in the open end of the battery cell container, which seals the open end; wherein the winding core is squeezed between the bottom surface of the battery cell container and the sealed cover, the bottom surface of the battery cell container being elastically deformed outwards in the axial direction.

### INCORPORATION BY REFERENCE

The disclosure of the following priority application is herein incorporated by reference: Japanese Patent Application No. 2010-017187, filed Jan. 28, 2010.

### BACKGROUND OF THE INVENTION

1. Field of the Invention

The present invention relates to a sealed battery cell in which an electrode group, in which a positive electrode, a negative electrode, and a separator are laminated together, is housed in a battery cell container.

2. Description of Related Art

With a prior art sealed battery cell in which an electrode group that includes electrodes wound around a core is housed within a battery cell container and is sealed therein, there is a fear as follows. If the battery cell is subjected to vibration, the electrode group may wobble there may be damage to the electrodes or failure of the battery cell, and a short circuit may occur between the positive and negative electrodes. In Japanese Laid-Open Patent Publication 2001-266947, a construction is proposed in which, in order to hold the electrode group, one end of the core in the axial direction is restricted and restrained and the other end of the core is elastically supported by an elastic member.

### SUMMARY OF THE INVENTION

However, with the sealed battery cell disclosed in Japanese Laid-Open Patent Publication 2001-266947, an elastic member is required between the top cover portion and the bottom portion of the container for elastically supporting the core, and this increases the cost. Moreover, it is difficult to check the state of this elastic support after the battery cell has been sealed.

According to the 1st aspect of the present invention, a sealed battery cell comprises: a coiled electrode group comprising a positive electrode, a negative electrode, and a separator wound around a winding core; a cylindrical battery cell container having an open end and a bottom surface, that contains the coiled electrode group; and a sealed cover swaged in the open end of the battery cell container, which seals the open end; wherein the winding core is squeezed between the bottom surface of the battery cell container and the sealed cover, the bottom surface of the battery cell container being elastically deformed outwards in the axial direction.

According to the 2nd aspect of the present invention, a sealed battery cell according to the 1st aspect may further comprise: a positive current collection component installed at one end of the winding core, and connected to the positive electrode of the coiled electrode group; and a negative current collection component installed at the other end of the winding core, and connected to the negative electrode of the coiled electrode group; and wherein the sealed cover is disposed over the positive current collection component, while the negative current collection component is disposed over the bottom surface of the battery cell container.

According to the 3rd aspect of the present invention, the negative current collection component of a sealed battery cell according to the 2nd aspect may be welded to the bottom surface of the battery cell container via a negative lead, and the winding core fits into and is fixed into the negative current collection component.

According to the 4th aspect of the present invention, it is preferred that in a sealed battery cell according to the 1st aspect, a central portion of the bottom surface of the battery cell container being elastically deformed constitutes an end surface in the axial direction of the battery cell container.

According to the 5th aspect of the present invention, it is preferred that in a sealed battery cell according to the 1st aspect, a central portion of the bottom surface of the battery cell container being elastically deformed is positioned inwards in an axial direction from an end surface in the axial direction of the battery cell container.

According to the 6th aspect of the present invention, a sealed battery cell comprises: a flattened electrode group in which a positive electrode, a negative electrode, and a separator are laminated together; a battery cell container with a flattened shape including at least a pair of sides, that contains the flattened electrode group; a top cover that is fixed in an open end of the battery cell container and seals the open end; a pair of positive and negative electrode group support members that supports the flattened electrode group from the top cover, one ends of which are supported by the top cover respectively and the other ends of which are connected to positive and negative electrode connection portions of the flattened electrode group respectively; and a pair of support blocks, each of which is interposed between one of the pair of electrode group support members and each of the sides of the battery cell container, and deforms each of the sides of the battery cell container to the exterior so as to exert restraining force upon the electrode group support member, each of the sides of the battery cell container facing each of the pair of the electrode group support members respectively.

According to the 7th aspect of the present invention, it is preferred that in a sealed battery cell according to the 6th aspect, the battery cell container is formed as a rectangular parallelepiped having two wide rectangular sides, two long narrow rectangular sides, a long narrow aperture defined by those four sides, and a long narrow rectangular bottom surface opposite to the long narrow aperture, the flattened electrode group being inserted into the battery cell container via the long narrow aperture; and each of the support blocks is interposed between one of the two long narrow rectangular sides and each of the pair of electrode group support members respectively so as to deform the long narrow rectangular sides elastically to the exterior.

According to the present invention, it is possible to support the electrode group elastically in the container without using any separate dedicated member, and moreover it is possible to inspect the condition of this support visually from the outside.

### BRIEF DESCRIPTION OF THE DRAWINGS

FIG. 1 is an exploded perspective view of a first embodiment of the sealed battery cell of the present invention;

FIG. 2 is a vertical sectional view of the sealed battery cell of FIG. 1;

FIG. 3A is a vertical sectional view showing a container of this battery cell before elastic deformation, and FIG. 3B is a vertical sectional view showing the battery cell container after it has been elastically deformed;

FIG. 4 is a vertical sectional view of a coiled electrode group of this first embodiment of the present invention, with positive and negative current collection members installed thereto;

FIG. 5 is a vertical sectional view showing a sealed cover and the battery cell container in which the coiled electrode group is received, according to the first embodiment;

FIG. 6 is a vertical sectional view for explanation of an example in which a secondary battery cell according to the first embodiment is installed in a casing;

FIGS. 7A and 7B are sectional views showing a first variant of the first embodiment of the sealed battery cell of the present invention: FIG. 7A shows the battery cell container before elastic deformation, and FIG. 7B shows the battery cell container after elastic deformation;

FIGS. 8A and 8B are sectional views showing a second variant of the first embodiment of the sealed battery cell of the present invention: FIG. 8A shows the battery cell container before elastic deformation, and FIG. 8B shows the battery cell container after elastic deformation;

FIG. 9A is a vertical sectional view showing a second embodiment of the sealed battery cell according to the present invention, and FIG. 9B is a perspective view of its battery cell container;

FIG. 10 is a perspective view showing the interior of this sealed battery cell according to the second embodiment;

FIG. 11 is a perspective view showing a flattened coiled electrode group of the sealed battery cell according to the second embodiment; and

FIG. 12 is a perspective view showing a flattened electrode group in a variant of the sealed battery cell according to the second embodiment.

### DESCRIPTION OF THE PREFERRED EMBODIMENTS

### The First Embodiment

Embodiments in which the sealed battery cell of the present invention is applied to a cylindrical lithium ion secondary battery cell will now be explained with reference to the drawings.

Overall Structure

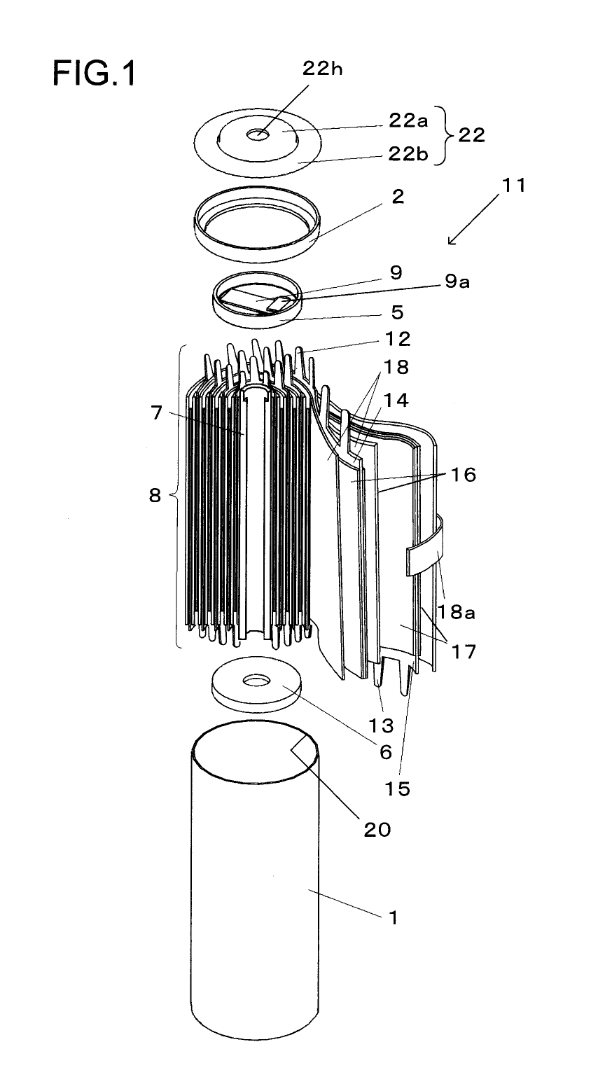

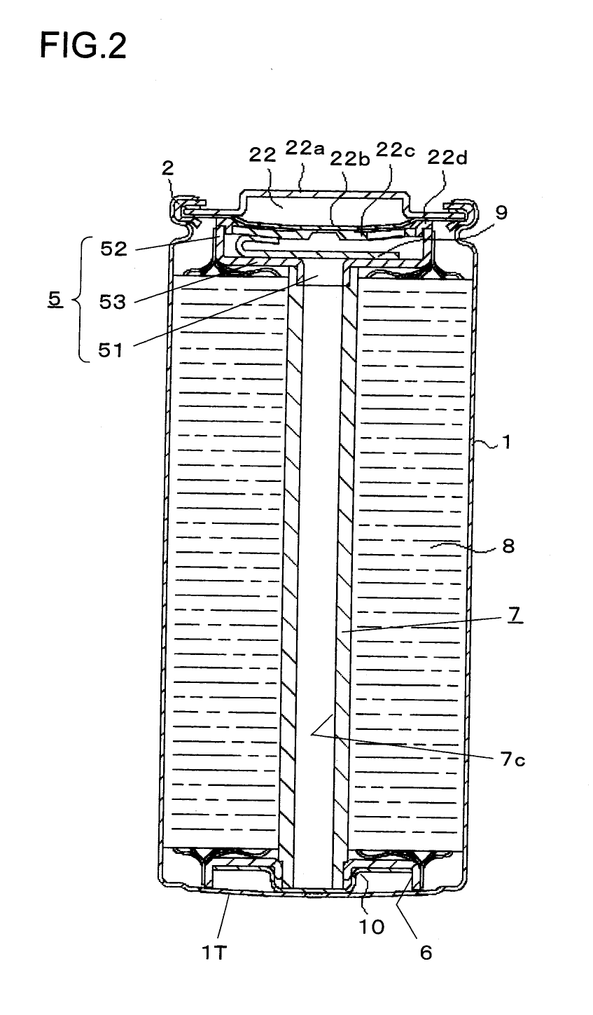

As shown in FIGS. 1 and 2, this cylindrical lithium ion secondary battery cell 11 includes a battery cell container 1 to one end of which an opening portion 20 is provided, and a coiled electrode group 8 that is housed in the interior of the battery cell container 1; and, along with electrolyte being injected into the interior of this battery cell container 1, the opening portion 20 is blocked by a sealed cover 22.

With this first embodiment of the secondary battery cell of the present invention, a winding core 7 of the coiled electrode group 8 is pressed against the bottom surface 1T of the cylindrical battery cell container 1, and the battery cell container 1 is sealed by the sealed cover 22. Due to this, the secondary battery cell 11 of this first embodiment is adapted so that the coiled electrode group 8 is restricted and restrained in the axial direction within the battery cell contained by the reaction force generated due to the fact that the bottom surface 1T is bulged outwards in the axial direction.

The Battery Cell Container

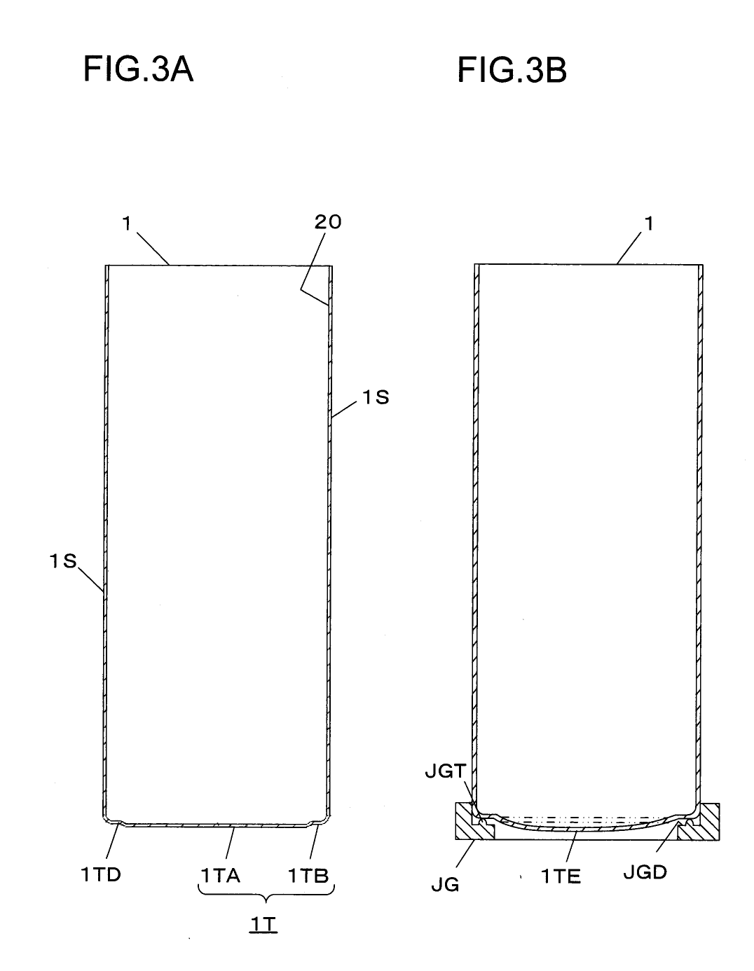

The battery cell container 1 before assembly is shown in FIG. 3A. This battery cell container 1 is a cylinder that has a bottom and also has the opening portion 20 at its upper portion, and it is made of nickel plated rolled steel sheet. The bottom surface 1T of the cylinder 1 includes an almost flat circular plate 1TA that generally constitutes and surrounds its central portion, and a flat circular annular plate 1TB that contacts the external periphery of the flat circular disk 1TA and continues radially outwards therefrom to the side wall 1S of the cylinder 1. A difference in level 1TD is provided between the flat circular disk 1TA and the flat circular annular plate 1TB.

An outwardly bulged portion 1TE on the bottom surface of the battery cell container 1 will now be explained, although this feature will be described in greater detail hereinafter. FIG. 3B is a figure for explanation of the bottom surface of the battery container 1, which is deformed when the sealed cover 22 is swaged to the battery cell container 1 using an assembly jig JG. It should be understood that, in FIGS. 3A and 3B, the structural components within the container 1 such as the coiled electrode group 8 and so on are omitted. The battery cell jig JG is formed in the shape of a circular plate, and an annular stepped portion JGD is provided thereon, defined by a small diameter aperture and a large diameter aperture. And an annular axially projecting portion JGT is provided upon this stepped portion JGD. When the sealed cover 22 is to be fixed to the battery cell container 1 by swaging, the battery cell container 1 is mounted upon this annular axially projecting portion JGT, and the sealed cover 22 is swaged to the battery cell container 1 while applying a load in the axial direction with the jig JG. Due to this swaging processing, the bottom surface 1T of the battery cell container 1 bulges downwards and becomes the bottom surface 1TE. In other words, the shape of the bottom surface 1T of the battery cell container 1 is flat (refer to FIG. 3A), but, when the sealed cover 22 is being fixed by swaging to the battery cell container 1, it is bulged outwards in the axial direction by 0.1 to 0.3 mm. Accordingly, this outwardly bulged portion 1TE now constitutes the axial end surface of the battery cell.

The Coiled Electrode Group

The coiled electrode group 8 will now be explained with reference to FIG. 1. This coiled electrode group 8 includes a positive electrode 14 and a negative electrode 15, and these are wound around a tubular core 7 that is made from resin, with the interposition of separators 18. These separators 18 are made from a porous insulating material. The outward end portions of the separators 18 are fixed with adhesive tape 18a. The positive electrode 14 is made from a thin metallic foil such as aluminum or the like, with a positive electrode mixture 16 being applied on both its surfaces. And a plurality of positive electrode tabs 12 are provided along the long edge of the positive electrode 14, on its side facing the opening portion 20. Similarly, the negative electrode 15 is made from a thin metallic foil such as copper or the like, with a negative electrode mixture 17 being applied on both its surfaces. And a plurality of negative electrode tabs 13 are provided along the long edge of the negative electrode 15, on its side facing the bottom portion of the battery cell container 1.

A positive current collection component 5 and a negative current collection component 6 are fitted to the two ends of the winding core 7.

The Positive Current Collection Component

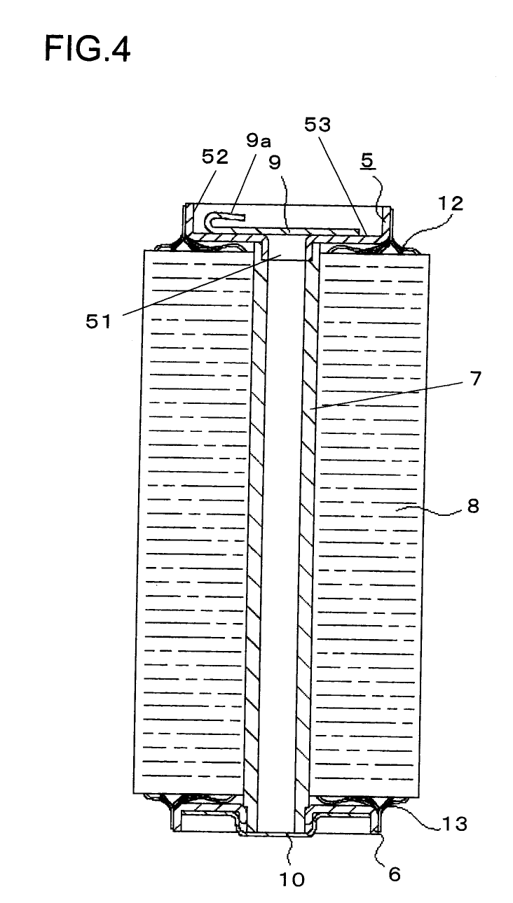

As shown in FIGS. 2 and 4, the positive current collection component 5 includes annular axially projecting portions 51 and 52 and an intermediate annular plate 53. At its central portion of the positive current collection component 5, the annular axially projecting portion 51 projects downwards towards the bottom portion of the battery cell container 1 and fits into the winding core 7. And the annular axially projecting portion 52 projects upwards towards the sealed cover 22 at the peripheral portion of the positive current collection component 5. Moreover, the intermediate annular plate 53 is a flat circular annulus that connects together the annular axially projecting portions 51 and 52. The positive current collection component 5 having this type of structure is integrated with the coiled electrode group 8 by the annular axially projecting portion 51 being fitted into the internal hole in the upper end of the winding core 7.

The positive electrode tabs 12 are welded to the outer peripheral surface of the positive current collection component 5, for example by an ultrasound welding method. And one end portion of a positive lead 9 that is shaped as a rectangular ribbon is welded to the upper surface of the intermediate annular plate 53 of the positive current collection component 5. The other end 9a of this positive lead 9 is welded to a positive electrode connection plate 22c (refer to FIG. 2) that is provided upon the rear surface of the sealed cover 22, so that thereby the positive electrode 14 is electrically connected to the sealed cover 22. The sealed cover 22 will be described hereinafter.

The Negative Current Collection Component

As shown in FIGS. 2 and 4, the negative current collection component 6 is made in the shape of a short cylinder that opens towards the bottom portion of the battery cell container 1, and has an axial holding portion that projects at its central portion. The winding core 7 is fitted into this axial holding portion. The negative electrode tabs 13 are welded to the outer peripheral surface of the negative current collection component 6, for example by an ultrasound welding method. A negative lead 10 that has a hat shaped cross section is welded to the bottom surface of the negative current collection component 6. The axial holding portion of the negative current collection component 6, into which the lower end of the winding core 7 is inserted, is fitted into a concave portion at the center of the negative lead 10. The bottom surface of the negative lead 10 is welded to the bottom surface 1T of the battery cell container 1, so that the negative current collection component 6 is electrically connected to the battery cell container 1, and the winding core 7 is fixed with respect to the battery cell container 1. As a result, the coiled electrode group 8 is restricted and restrained at its negative electrode end.

The Sealed Cover

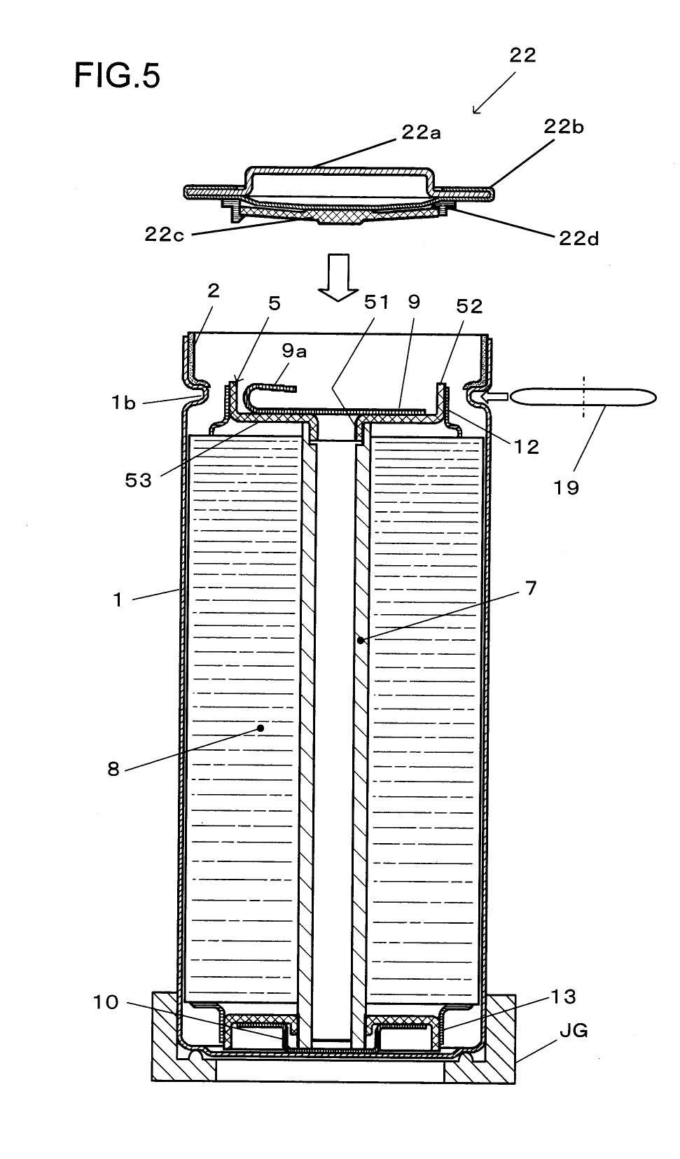

As shown in FIG. 5, the sealed cover 22 includes a cap 22a that has an exhaust aperture 22h (refer to FIG. 1), a top cover case (diaphragm) 22b, a positive electrode connection plate 22c, and an insulation ring 22d. The top cover case (diaphragm) 22b has cleavage grooves not shown in the figure, and is installed to the cap 22a. The positive electrode connection plate 22c is spot welded to the rear surface of the central portion of the top cover case 22b. And the insulation ring 22d is sandwiched between the upper surface of the outer edge of the positive electrode connection plate 22c and the outer peripheral portion of the rear surface of the top cover case 22b.

The cap 22a is formed in the shape of a hat, and has a convex portion that projects upwards from the battery cell container 1 at its central portion. This convex portion of the cap 22a constitutes a positive electrode terminal for the battery cell. The top cover case 22b is fixed to the peripheral part of the cap 22a by a swaging process. The cap 22a is make from nickel plated iron (SPCC), while the top cover case 22b and the positive electrode connection plate 22c are made from aluminum; and the top cover case 22b, the cap 22a, and the positive electrode connection plate 22c are electrically connected together.

As described above, the positive lead 9 is connected to the rear surface of the positive electrode connection plate 22c, so that the cap 22a is electrically connected to the positive electrode 14 via the top cover case 22b, the positive electrode connection plate 22c, the positive lead 9, and the positive current collection component 5.

The peripheral part of the sealed cover 22 is fixed to the battery cell container 1 by a swaging process, via the insulation gasket 2. Due to this, the external diameter of the peripheral part of the top cover case 22b that is swaged to the peripheral part of the cap 22a is almost equal to the internal diameter of the inner circumferential surface of the battery cell container 1.

The sealed cover 22 constitutes an anti-explosion mechanism. When, due to generation of gas in the interior of the battery cell container 1, its internal pressure rises to an abnormally high level, then the top cover case 22b suffers cracking at its cleavage grooves. And then the internal gas is vented via these cracks that have appeared in the top cover case 22b and is discharged from the exhaust aperture 22h of the cap 22a, so that the pressure interior to the battery cell container 1 is reduced. Furthermore, the electrical connection to the positive electrode connection plate 22c is broken due to the top cover case (i.e. diaphragm) 22b bulging outwards from the battery cell container 1 due to the internal pressure therein, so that the flow of excessive electrical current is prevented.

The Procedure for Assembly of the Battery Cell

The procedure for assembly of the various structural elements described above will now be explained.

As shown in FIG. 5, the electrode group in which the positive and negative current collection components 5 and 6 have been installed is loaded into the battery cell container 1, and the negative lead 10 is passed through the hollow through hole 7c in the winding core 7 and is fixed to the bottom surface 1T of the battery cell container 1 by welding. Then the entire circumference of the neighborhood of the opening portion 20 is squeezed radially inward in the direction towards the center of the container with a squeezing jig 19, so that a waisted portion 1b is formed at the upper portion of the container 1.

The other end 9a of the positive lead 9 that is welded to the intermediate annular plate 53 of the positive current collection component 5 is welded to the rear surface of the positive electrode connection plate 22c of the sealed cover 22. Electrolyte is injected into the battery cell container 1, and the battery cell container 1 is mounted upon the jig JG. Then the sealed cover 22 is mounted upon the positive current collection component 5 by being moved in the direction of the arrow in the drawing, and a predetermined load F1 in the axial direction is imposed from the sealed cover 22 by a pressurization jig not shown in the figures. The annular axially projecting portion 51 at the center of the lower surface of the positive current collection component 5 is thus fitted into the winding core 7, and the load F1 operates via the winding core 7 upon the bottom surface 1T of the battery cell container 1. As a result, the bottom surface 1T is bulged outward, as shown by the outwardly bulged portion 1TE in FIG. 3B.

With this predetermined load F1 in the axial direction being maintained without release, in the state with the insulation gasket 2 disposed in the opening portion 20, the sealed cover 22 is pushed into the opening portion 20 and is fitted tightly thereinto, and thereby the opening portion 20 is blocked. Due to this type of swaging process, the sealed cover 22 is fixed to the battery cell container 1 via the insulation gasket 2. The insulation gasket 2 seals the periphery of the sealed cover 22 against ingress of water, along with providing electrical insulation between the sealed cover 22 and the battery cell container 1.

It should be understood that the insulation gasket 2 may be made from perfluoroalkoxy-fluoroplastic resin (PFA).

The cylindrical secondary battery cell according to the first embodiment of the present invention described above includes the coiled electrode group 8 in which the positive electrode 8E, the negative electrode 8D, and the separators 8E are wound upon the winding core 7, the cylindrical battery cell container 1 that contains this coiled electrode group 8, and the sealed cover 22 that is swaged in the open end 20 of the battery cell container 1 and seals this open end, with the winding core 7 being squeezed between the bottom surface 1TE of the battery cell container 1 and the sealed cover 22, and with the bottom surface 1TE of the battery cell container 1 being elastically deformed outwards in the axial direction.

When as described above the sealed cover 22 is fixed to the battery cell container 1 by swaging, the winding core 7, the positive current collection component 5, and the negative current collection component 6 are sandwiched and squeezed in the axial direction between the sealed cover 22 and the bottom surface 1TE by the reaction force of the bottom surface 1TE, so that the coiled electrode group 8 is held and restrained within the battery cell container 1. Due to this elastic support, when this cylindrical lithium ion secondary battery cell 1 is subjected to shock or vibration, the coiled electrode group 8 is stably supported and fixed and does not wobble, so that it is possible to prevent damage to and failure of the electrodes and other structural components, and also short circuiting.

Furthermore, since it is possible to check the state of elastic deformation of the battery cell container bottom surface 1TE from the exterior, it is possible to ascertain the effectiveness by which the coiled electrode group 8 is being held and supported, even after the battery cell container 1 has been sealed.

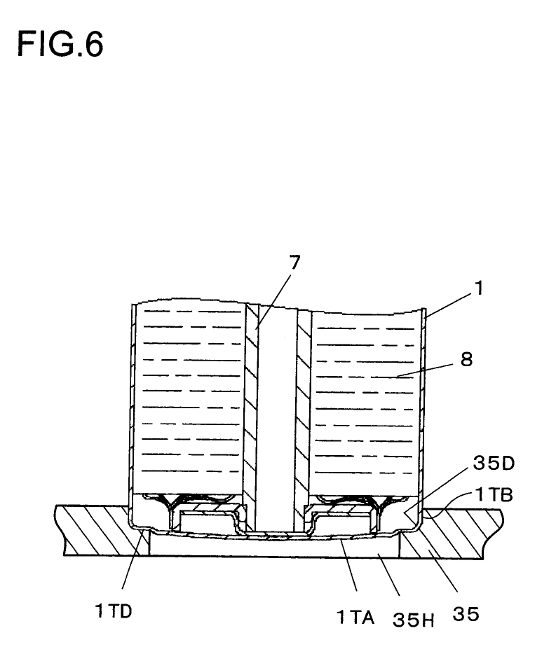

A plurality of cylindrical lithium ion secondary battery cells 11 constructed as described above may, for example, be enclosed within a casing and may be used as a power supply device. FIG. 6 is a figure showing an example of how such a secondary battery cell 11 may be installed in a casing 35. A battery cell installation hole 35H is formed in the module casing 35. A stepped portion 35D is formed in this battery cell installation hole 35H with a small diameter hole and a large diameter hole. As described above, a difference in level 1TD is provided between the flat circular disk 1TA and the flat circular annulus 1TB, and this difference in level 1TD fits into the stepped portion 35D of the casing 35 of the secondary battery cell 11, so that the secondary battery cell 11 is stably supported.

### Variant #1 of the First Embodiment

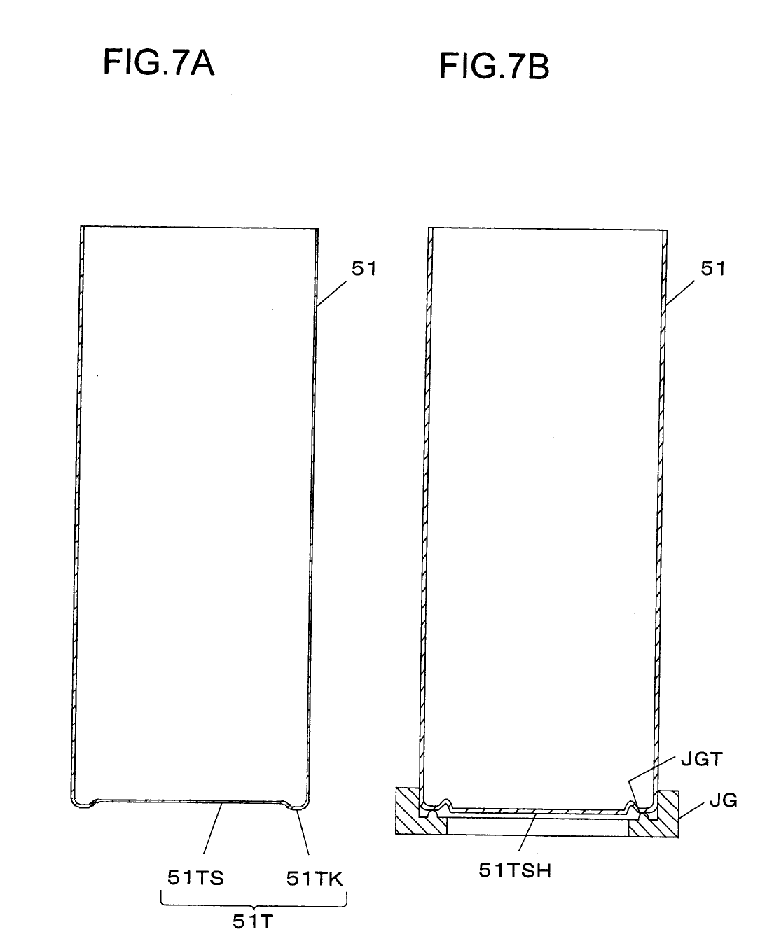

It would also be acceptable to use a battery cell container 51 made as shown in FIG. 7A. The bottom surface 51T of this battery cell container 51 has an annular portion 51TK provided to surround the external periphery of a circular portion 51TS that covers the central portion of its bottom surface. And FIG. 7B is a figure for explanation of the bottom surface of the battery cell container 51 after it has been deformed by the use of an assembly jig JG during swaging of the sealed cover 22 to the top of the battery cell container 51. The battery cell jig JG is the same as the jig JG shown in FIG. 3B. When the sealed cover is to be fixed to the top of the battery cell container 51 by swaging, the battery cell container 51 is mounted upon the annular axially projecting portion JGT, and the sealed cover 22 is swaged to the battery cell container 51 while imposing a load in the axial direction with the jig JG. Due to the swaging processing, the circular portion 51TS of the battery cell container 51 is deformed and reaches a shape as shown by the bottom surface 51TSH.

With the battery cell container 51 of this first variant embodiment, when the sealed cover 22 is fixed by swaging to the battery cell container 51, even though the circular portion 51T bulges outwards in the axial direction by 0.1 to 0.3 mm, still the circular portion 51TDE does not project from the end surface of the battery cell container 51 in the axial direction after deformation, so that the bottom surface of the container 51 remains approximately flat.

### Variant #2 of the First Embodiment

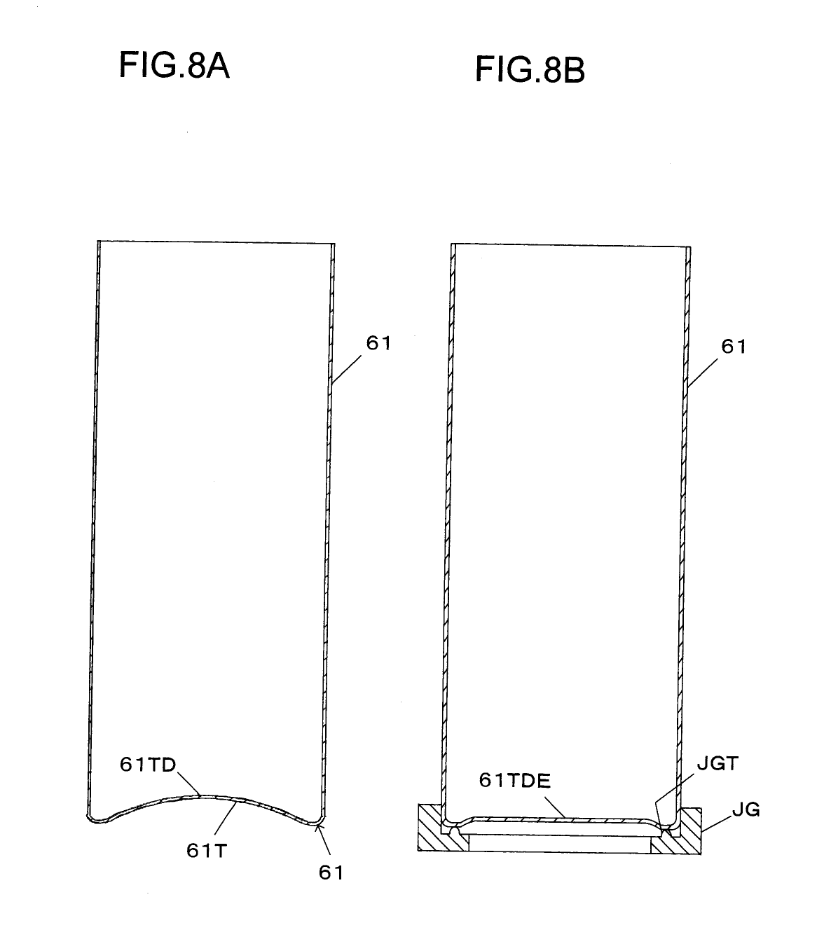

It would also be acceptable to use a battery cell container 61 made as shown in FIG. 8A. The bottom surface 61T of this battery cell container 61 has a circular hollow portion 61TD concaved into a dome shape over the central portion of its bottom surface. And FIG. 8B is a figure for explanation of the bottom surface of the battery cell container 61 after it has been deformed by the use of an assembly jig JG during swaging of the sealed cover 22 to the top of the battery cell container 61. The battery cell jig JG is the same as the jig JG shown in FIG. 3B, and, as explained with reference to the first variant embodiment, when the sealed cover is to be fixed to the top of the battery cell container 61 by swaging, the battery cell container 61 is mounted upon the annular axially projecting portion JGT, and the sealed cover 22 is clinched to the battery cell container 61 while imposing a load in the axial direction with the jig JG. Due to the swaging processing, the circular hollow portion 61TD of the battery cell container 61 is deformed and reaches a shape as shown by the bottom surface 61TDE.

With the battery cell container 61 of this second variant embodiment, when the sealed cover 22 is fixed by swaging to the battery cell container 61, even though the circular portion 61T bulges outwards in the axial direction by 0.1 to 0.3 mm, still the circular portion 61TDE does not project from its position well within the axial end surface of the battery cell container 61.

### The Second Embodiment

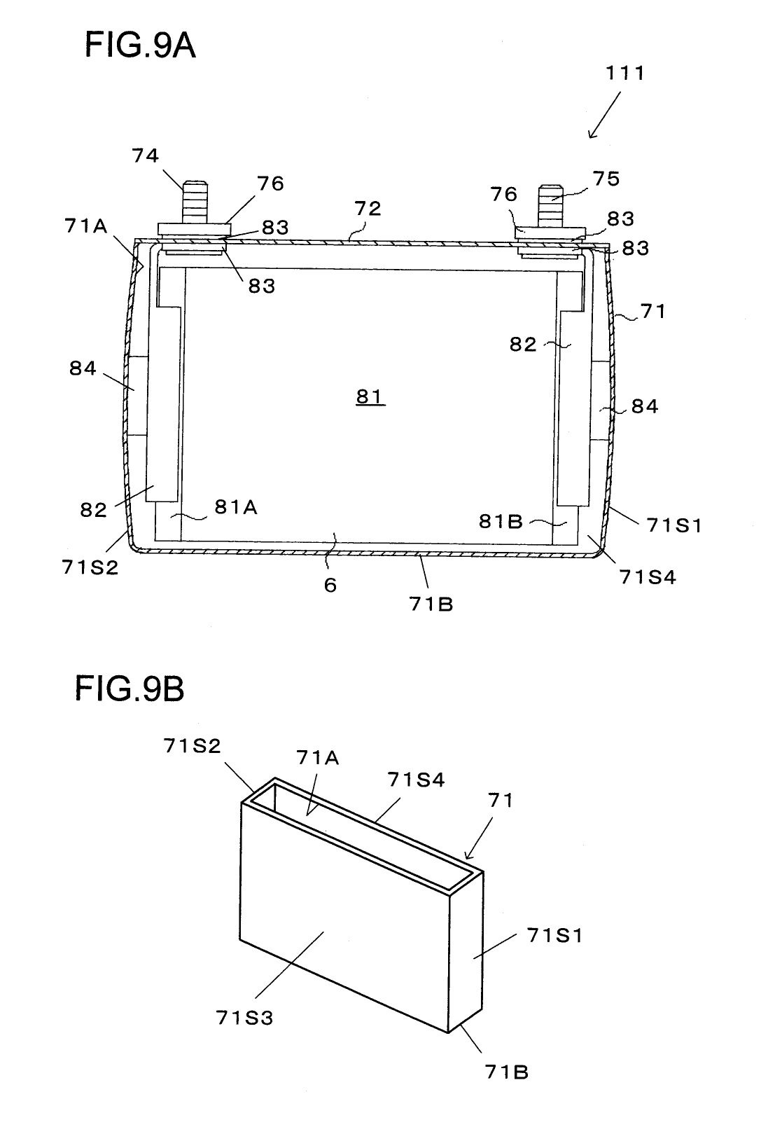

A second embodiment in which the secondary battery cell according to the present invention is embodied as a square type flattened secondary battery cell will now be explained with reference to FIGS. 9A and 9B through 12. It should be understood that elements that are the same or that correspond to ones of the first embodiment are denoted by the same reference symbols, and explanation thereof will be omitted.

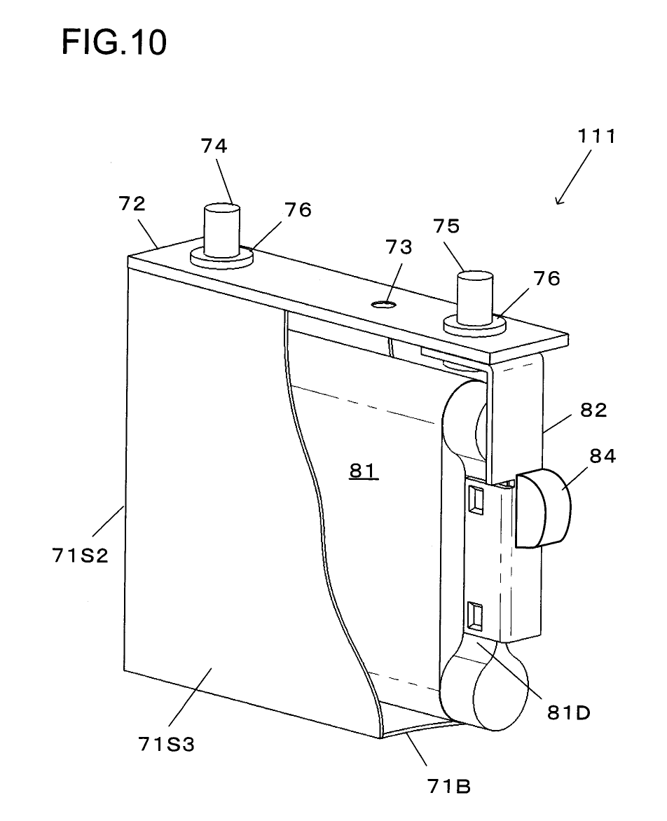

As shown in FIGS. 9A, 9B, and 10, this sealed battery cell 111 has a battery cell container 71 that is shaped as a flattened rectangular parallelepiped, and a coiled electrode group 81 is housed in the interior of this battery cell container 71. This battery cell container 71 formed as a flattened rectangular parallelepiped has sides 71S1 and 71S2 shaped as elongated rectangles, sides 71S3 and 71S4 that are quite wide, an opening portion 71A, and a battery cell container bottom surface 71B. The wider surfaces 71S3 and 71S4 are connected to the elongated rectangular sides 71S1 and 71S2. And the opening portion 71A is demarcated by the edges of the sides 71S1 through 71S4, and is blocked by a top cover 72. It should be understood that an electrolyte filling aperture 73 is provided by being drilled through the top cover 72, for injection of electrolyte into the interior of the battery cell container 71.

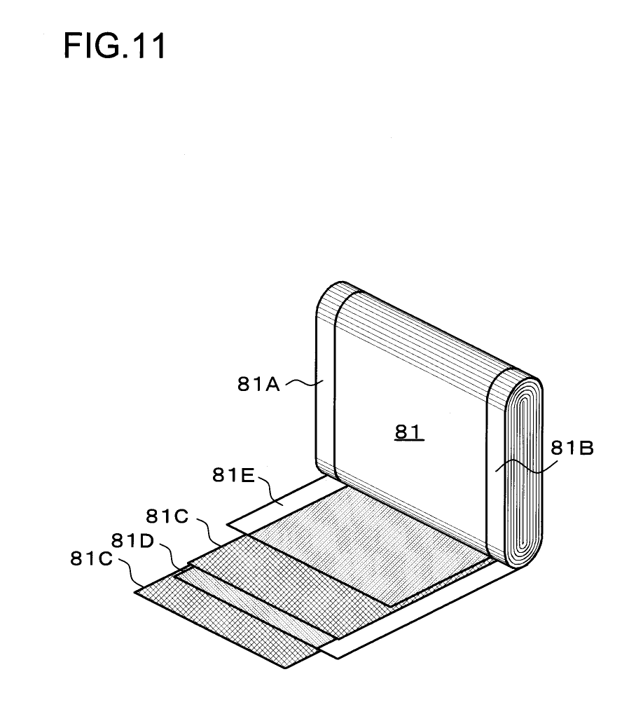

As shown in FIG. 11, the coiled electrode group 81 is made by rolling up a positive electrode plate 81E (coated with positive electrode material) and a negative electrode plate 81D (coated with negative electrode material) with the intervention of separators 81C. During this rolling up process, one separator 81C, the negative plate 81D, another separator 81C, and the positive plate 81E are overlapped over one another in that order, and then they are rolled up from one end so as to form a roll having an approximately elliptical cross sectional shape. At this time, an uncoated portion 81A of the positive plate 81E and an uncoated portion 81B of the negative plate 81B are arranged at mutually opposite ends of the roll. Moreover, in around two or three turns at the portion where rolling up starts and the portion where rolling up ends, only the separators 81C are present, because the positive and negative plates 81E and 81D are made to be shorter than the separators 81C.

The positive plate 81E included in the coiled electrode group 81 is made from aluminum foil that constitutes a positive current collection foil, and, on both sides of this aluminum foil, a positive electrode active material mixture that includes lithium-containing transition metal oxide such as manganese lithium oxide or the like as a positive electrode active material is spread and adhered approximately equally and uniformly. Apart from this positive electrode active material, an electrically conductive material such as a carbonaceous material or the like and a binder (i.e. a bonding substance) such as polyvinylidene fluoride (hereinafter abbreviated as PVDF) or the like are combined into the positive electrode active material mixture. During the coating of the positive electrode active material mixture onto the aluminum foil, the viscosity may be adjusted with a dispersal solvent such as N-methyl-pyrrolidone (hereinafter abbreviated as NMP) or the like.

At this time, the uncoated portion 81A is formed by one of the long edges of the aluminum foil not being coated with the positive electrode active material mixture. In other words, the aluminum foil is exposed over this uncoated portion 81A. Then the density of this positive plate 81E is adjusted by rolling pressing, after it has been dried.

On the other hand, the negative plate 81D included in the coiled electrode group 81 is made from copper foil that constitutes a negative current collection foil. And on both sides of this copper foil, a negative electrode active material mixture that includes a carbonaceous material such as graphite or the like that can reversibly either occlude or emit lithium ions is spread and adhered as a negative electrode active material, approximately equally and uniformly. Apart from this negative electrode active material, an electrically conductive material such as acetylene black or the like and a binder such as PVDF or the like are combined into this negative electrode active material mixture. During the coating of the negative electrode active material mixture onto the copper foil, the viscosity may be adjusted with a dispersal solvent such as NMP or the like. At this time, the uncoated portion 81B is formed by one of the long edges of the copper foil not being coated with the negative electrode active material mixture.

In other words, the copper foil is exposed over this uncoated portion 81B. Then the density of this negative plate 81D is adjusted by rolling pressing, after it has been dried. It should be understood that the length of the negative plate 81D is set to be longer than the length of the positive plate 81E, so that, when the positive plate 81E and the negative plate 81D are rolled up, the positive plate 81E does not experience disturbance from the negative plate 81D in the winding direction at the innermost turn and the outermost layer.

The uncoated portions 81A and 81B are arranged to face the elongated rectangular side surfaces 71S1 and 71S2 of the battery cell container 71. An electrically conductive electrode group support member 82 is connected to each of these uncoated portions 81A and 81B, and these electrode group support members are supported by the top cover 72. In other words, the uncoated portions 81A and 81B constitute respective positive and negative electrode connection portions.

Connecting terminals 74 and 75 shaped as bolts are fitted to the top cover 72 from the interior, and these connection terminals 74 and 75 function as external positive and negative electrodes, respectively. The connection terminals 74 and 75 are passed through the electrode group support members 82 and the top cover 72 and are held on by external nuts 76, and thereby the connection terminals 74 and 75 and the electrode group support members 82 are solidly fixed to the top cover 72.

Gaskets 83 that are made from an insulating material are inserted between the nuts 76 and the electrode group support members 82, and the top cover 72, so that sealing structures are provided around the connection terminals 74 and 75 against the escape of electrolyte from the interior of the battery cell container 71. The top cover 72 is fixed to the battery cell container 71 by welding.

A support block 84 that projects sideways is fixed to each of the electrode group support members 82. Since the sides 71S1 and 71S2 are pressed outwards by these support blocks 84, accordingly the sides 71S1 and 71S2 are elastically deformed. The support blocks 84 are made using a resin material or the like, and accordingly the uncoated portions 81A and 81B are insulated from the battery cell container 71.

The electrode group support members 82 are elastically supported by the resilient force due to elastic deformation of the sides 71S1 and 71S2, and, due to this, the coiled electrode group 81 is supported and fixed within the battery cell container 71. The sides 71S1 and 71S2 are shaped as elongated rectangles, and their rigidity is high as compared with the larger sides 71S3 and 71S4, so that they are capable of generating a high elastic support force. The coiled electrode group 81 has a comparatively fragile construction due to the positive electrode 81E, the negative electrode 81D, and the separators 81C being wound together into a roll, so that it is not desirable for much load to be applied directly to it. Due to this fact, the electrode group support members 82 are made to have high strength and rigidity, so that the coiled electrode group 81 is protected.

As described above, the flattened type secondary battery cell according to the second embodiment of the present invention includes: the flattened electrode group 81 in which the positive electrode 81E, the negative electrode 81D, and the separators 81C are laminated together; the battery cell container 71 having a flattened shape, that contains the flattened electrode group 81; the top cover 72 that is fixed in the open end 71A of the battery cell container 71 and seals the open end 71A; the pair of positive and negative electrode group support members 82, the one ends of which are supported by the top cover 72, and the other ends of which are connected to the positive and negative electrode connection portions 81A and 81B of the flattened electrode group 81 and support the flattened electrode group 81 from the top cover 72; and the pair of support blocks 84, each of which is interposed between one of the pair of electrode group support members 82 and a side 71S1 or 71S2 of the battery cell container 71 that faces it, and deforms that side 71S1 or 71S2 of the battery cell container 71 to the exterior so as to exert restraining force upon the electrode group support member 82.

According to the structure described above, the coiled electrode group 81 is supported by the electrode group support members 82, and also is pressed by the battery cell container 71 via the support blocks 84. Due to this, if the sealed battery cell 111 is subjected to vibration, the coiled electrode group 81 does not wobble very much, so that it is possible to prevent damage to the electrodes, and short circuiting thereof.

It should be understood that, instead of the support blocks 84 being fixed to the electrode group support members 82, they could also be fixed to the interiors of the sides 71S1 and 71S2 of the battery cell container 71.

According to this flattened type secondary battery cell of the second embodiment, in a similar fashion to the beneficial effect obtained with the first embodiment, the beneficial effect is obtained that it is possible to hold the electrode group in a stable manner.

### A Variant of the Second Embodiment

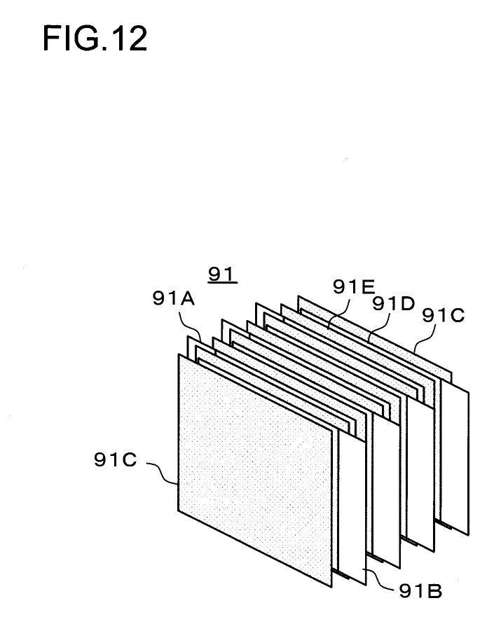

Instead of the structure for the electrode group 81 shown in FIG. 11 in which the positive and negative plates and the separators are coiled together, it would also be possible to employ a structure like that shown in FIG. 12. As shown in FIG. 12, with this laminated type electrode group 91, rectangular shaped positive plates 91E and rectangular shaped negative plates 91D are overlapped together alternatingly, with the interposition of rectangular shaped separators 91C. In this case, the overlapping is performed so that the uncoated portions 91A and 91B appear at the opposite side surfaces of the laminated electrode group 91.

With the laminated type electrode group 91 of this variant embodiment, the positive electrode side electrode support member 82 is connected to the uncoated portions 91A, while the negative electrode side electrode support member 82 is connected to the uncoated portions 91B, and these two electrode support members 82 are fixed to the top cover 72. The support blocks 84 are interposed between the pair of electrode support members 82 and the elongated rectangular sides 71S1 and 71S2 and the sides 71S1 and 71S2 are elastically deformed outwards by the pressure exerted by the blocks 84, and thereby the electrode support members 82, and the electrode group 91 as well, are stably supported within the battery cell container.

The above described embodiments are examples, and various modifications can be made without departing from the scope of the invention.

What is claimed is:

1. A sealed battery cell, comprising:
a coiled electrode group comprising a positive electrode, a negative electrode, and a separator wound around a winding core;
a cylindrical battery cell container having an open end and a bottom surface, that contains the coiled electrode group; and
a sealed cover swaged in the open end of the battery cell container, which seals the open end; wherein
the winding core is squeezed between the bottom surface of the battery cell container and the sealed cover, the bottom surface of the battery cell container being elastically deformed outwards in the axial direction.

2. A sealed battery cell according to claim 1, further comprising:
a positive current collection component installed at one end of the winding core, and connected to the positive electrode of the coiled electrode group; and
a negative current collection component installed at the other end of the winding core, and connected to the negative electrode of the coiled electrode group; and wherein
the sealed cover is disposed over the positive current collection component, while the negative current collection component is disposed over the bottom surface of the battery cell container.

3. A sealed battery cell according to claim 2, wherein
the negative current collection component is welded to the bottom surface of the battery cell container via a negative lead, and the winding core fits into and is fixed into the negative current collection component.

4. A sealed battery cell according to claim 1, wherein
a central portion of the bottom surface of the battery cell container being elastically deformed constitutes an end surface in the axial direction of the battery cell container.

5. A sealed battery cell according to claim 1, wherein
a central portion of the bottom surface of the battery cell container being elastically deformed is positioned inwards in an axial direction from an end surface in the axial direction of the battery cell container.

6. A sealed battery cell, comprising:
a flattened electrode group in which a positive electrode, a negative electrode, and a separator are laminated together;
a battery cell container with a flattened shape including at least a pair of sides, that contains the flattened electrode group;
a top cover that is fixed in an open end of the battery cell container and seals the open end;
a pair of positive and negative electrode group support members that supports the flattened electrode group from the top cover, one ends of which are supported by the top cover respectively and the other ends of which are connected to positive and negative electrode connection portions of the flattened electrode group respectively; and
a pair of support blocks, each of which is interposed between one of the pair of electrode group support members and each of the sides of the battery cell container, and deforms each of the sides of the battery cell container to the exterior so as to exert restraining force upon the electrode group support member, each of the sides of the battery cell container facing each of the pair of the electrode group support members respectively.

7. A sealed battery cell according to claim 6, wherein:
the battery cell container is formed as a rectangular parallelepiped having two wide rectangular sides, two long narrow rectangular sides, a long narrow aperture defined by those four sides, and a long narrow rectangular bottom surface opposite to the long narrow aperture, the flattened electrode group being inserted into the battery cell container via the long narrow aperture; and
each of the support blocks is interposed between one of the two long narrow rectangular sides and each of the pair of electrode group support members respectively so as to deform the long narrow rectangular sides elastically to the exterior.
